(19) United States
(12) Patent Application Publication
(10) Pub. No.: US 2010/0159187 A1
(43) Pub. Date: Jun. 24, 2010

(54) Laminating System and Method

(76) Inventors: Lindsey Brenda Seymour, Johannesburg (ZA); Adam Seymour, Johannesburg (ZA); Pieter Meriring Viljoen, Boksburg (ZA); Wessel Gerber, Springs (ZA)

Correspondence Address: NIXON PEABODY, LLP, 401 9TH STREET, NW, SUITE 900, WASHINGTON, DC, 20004-2128, US

(21) Appl. No.: 11/547,543

(22) PCT Filed: Mar. 29, 2005
(86) PCT No.: PCT/IB05/00800

§ 371 Date: Dec. 21, 2007

(30) Foreign Application Priority Data
Apr. 1, 2004 (ZA) 2004/2588

(51) Int. Cl. B32B 21/14; B32B 37/18; B29C 65/02

(52) U.S. Cl. 428/106; 156/380.9; 156/299

(57) ABSTRACT

A system (10) for laminating a plurality of veneer layers (14, 18) is disclosed. The system (10) comprises a base veneer layer roll (12) carrying a base veneer layer (14) and at least one additional roll (16) carrying at least one additional veneer layer (18) that is to be laminated to the base veneer layer (14). Guiding means (24, 28) is provided for guiding the two layers (14, 18) towards each other, with a pair of adjacent laminating rollers (30, 32) being arranged to receive the base veneer layer (14) and the additional veneer layer (18) therebetween, so as to continuously laminate the two layers (14, 18) as they move through the laminating rollers (30, 32). Preferably, the additional veneer layer (18) is impregnated with heat-activatable glue, with the system (10) further including a bank of heating elements (40) arranged to activate the glue on the additional veneer layer (18).

### BACKGROUND OF THE INVENTION

THIS invention relates to a system for and method of laminating layers, and in particular layers of veneer in roll form.

At present, layers are laminated by means of a system comprising a plurality of supply rolls carrying the veneer layers, with the layers then being pressed together by means of a press that is approximately 20 m in length.

Significantly, existing veneer rolls have PVA glue already applied to the layers, the glue being activated, so as to become tacky, by means of heat.

The above arrangement has a number of problems. Firstly, there is the real possibility of overpressing or underpressing the layers. Secondly, the use of PVA glue requires the water in the PVA glue to first be removed by means of a flashing process, before the layers can be pressed together. If the water is not flashed off properly, steam bubbles will form during the pressing process, which will render the resulting pressed layers unusable. The resulting product will inevitably be discarded, not only causing significant financial losses but also loss of production time. Thirdly, since the production process temporarily comes to a halt whilst the layers are being pressed, the above system is extremely inefficient. Finally, there is no checking means for ensuring that the layers, as they are being pressed, are kept aligned. Thus, in practice, layers move sideways during the pressing process, resulting in an incomplete laminated product.

It would therefore be desirable to provide a laminating system and method that addresses the above disadvantages.

### SUMMARY OF THE INVENTION

According to a first aspect of the present invention, there is provided a system for laminating a plurality of veneer layers, the system comprising:
a base veneer layer roll for carrying a base veneer layer;
at least one additional roll for carrying at least one additional veneer layer that is to be laminated to the base veneer layer;
guiding means for guiding the two layers towards each other; and
a pair of adjacent laminating rollers for receiving the base veneer layer and the additional veneer layer therebetween, so as to continuously laminate the two layers as they move through the laminating rollers.

Conveniently, the additional veneer layer is impregnated with heat-activatable glue, with the system further including a bank of heating elements arranged to activate the glue on the additional veneer layer.

Typically, the glue is EVA hotmelt glue.

Advantageously, the system further includes a dynamic alignment arrangement for controlling the alignment of the veneer layers as they pass through the system.

Preferably, the alignment arrangement includes:
at least one monitoring element for determining the alignment of the layers as they pass through the system; and
actuating means connected to the at least one monitoring element for adjusting the alignment of the layers.

According to a second aspect of the present invention, there is provided a method of laminating veneer layers, the method comprising the steps of:
providing a base veneer layer;
providing at least one additional veneer layer that is to be laminated to the base veneer layer;
guiding the two layers towards each other; and
providing a pair of adjacent laminating rollers for receiving the base veneer layer and the additional veneer layer therebetween, so as to continuously laminate the two layers as they move through the laminating rollers.

Conveniently, the additional veneer layer is impregnated with heat-activatable glue.

Preferably, the method includes the step of activating the glue on the additional veneer layer.

Advantageously, the method further includes the step of controlling the alignment of the veneer layers.

According to a third aspect of the present invention, there is provided a roll of laminated veneer layers, made with the system and/or according to the method defined above.

### BRIEF DESCRIPTION OF THE DRAWINGS

FIG. 1 is a schematic side view of a veneer laminating system according to the present invention; and

FIG. 2 is a top view of a section of the laminating system shown in FIG. 1, highlighting the dynamic alignment arrangement for controlling the alignment of the veneer layers as they pass through the system.

### DESCRIPTION OF THE PREFERRED EMBODIMENT

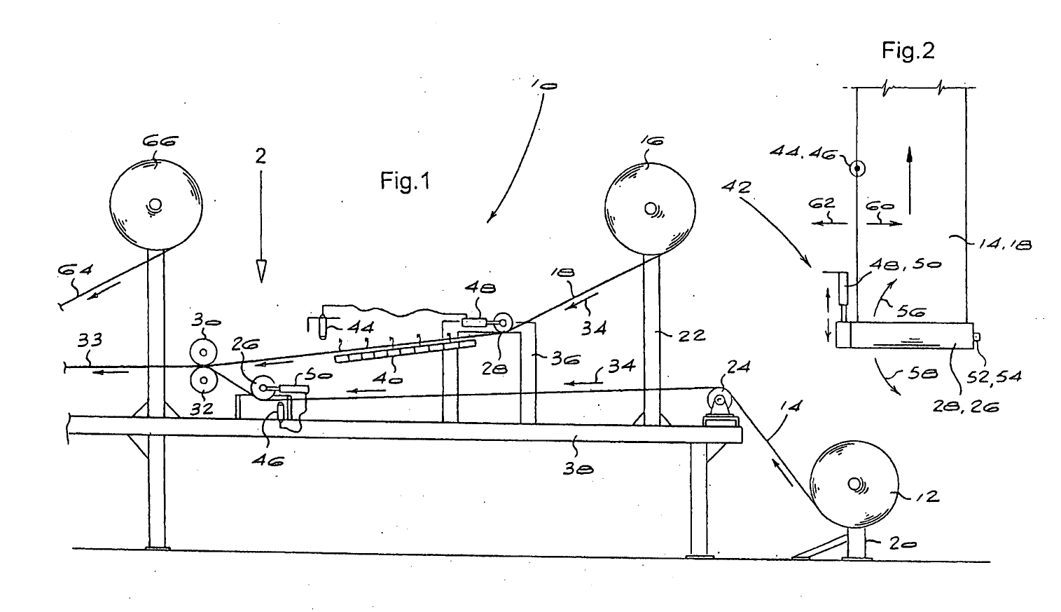

Referring to FIG. 1, a laminating system 10 for laminating veneer layers comprises a base veneer layer roll 12 carrying a base veneer layer 14, as well as an additional roll 16 carrying the veneer layer 18 that is to be laminated to the base layer 14. The rolls 12, 16 are rotatably mounted to support posts 20 and 22, respectively.

The base veneer layer 14 passes over a first roller 24 and then under a second roller 26. The additional layer 18 passes under a third roller 28, before being pressed to the base layer 14 by a pair of adjacent laminating rollers 30, 32, so as to define laminated layer 33. The layers 14, 18 move in the direction indicated by arrows 34. The third roller 28 is mounted to a support 36 that is carried by a support platform 38, which also supports the first and second rollers 24, 26.

The additional veneer layer 18 coming off roll 16 is impregnated with heat-activatable glue, with a bank of heating elements 40 being used to activate the glue on this layer 18. In particular, the preferred glue used is EVA hotmelt glue that, advantageously, does not contain water that first needs to be flashed off, as does the PVA glue described above.

The system 10, and with particular reference to FIG. 2, includes a dynamic alignment or tracking arrangement 42 for controlling the alignment of the veneer layers 14,18 as they pass through the system 10. The alignment arrangement 42 includes a pair of monitoring eyes 44 and 46, with eye 44 being associated with roller 28 and eye 46 being associated with roller 26. These eyes 44, 46 determine the alignment of the layers 14, 18 as they pass through the system 10, the eyes 44, 46 defining an input to control actuating means 48, 50 for controlling the position of the rollers 28, 26, respectively, and thereby the alignment of the layers 14, 18.

Advantageously, the rollers 26, 28 are mounted to pivot points 52, 54, with the other end of the roller 26, 28 being connected to the actuating means 48, 50, typically a pneumatic cylinder, so that the rotational displacement of the rollers 26, 28, indicated by arrows 56 and 58, enables the alignment of the layers 14, 18 to be regulated. Thus, if the eyes 44, 46 determine that the layer 14, 18 is moving in the direction of arrow 60 the relevant roller is moved in the direction of arrow 56 to compensate, and thus bring the layer back into alignment, and vice versa.

A significant advantage of the present invention is that a third layer 64 can easily be laminated to the already laminated layer 33 by simply locating the roll 66 carrying the third layer 64 at or adjacent the pair of laminating rollers 30, 32. It is envisaged that up to six veneer layers can be laminated together using the system of the present invention, by simply and repeatedly laminating an additional layer onto an already laminated layer.

Typically, the width of the veneer can vary from 40 mm to 300 mm, with the length of the roll of laminated product varying from 10 m to 400 m, depending on the thickness of the individual veneer layer. The layers move through the system at between 1 metre per minute and 18 metres per minute, which makes the laminating process extremely quick.

Although not shown, the final laminated product is then sent through a pressure roller set, comprising a pair of rollers similar to the rollers 30, 32, and thereafter through a cooling tunnel for cooling the product. The cooling tunnel typically comprises a plurality of fans for blowing air onto the product from above, with a cold, refrigerated panel being located below the product for further cooling the product. Thereafter, the laminated product is rolled onto a roll, with the product then being complete and ready for dispatch or to be slit down to smaller widths and sanded.

One of the advantages of the present invention is that the resulting product is extremely flexible, which enables it to be easily and accurately slit into smaller widths.

1. A system for laminating a plurality of veneer layers, the system comprising:
a base veneer layer roll for carrying a base veneer layer;
at least one additional roll for carrying at least one additional veneer layer that is to be laminated to the base veneer layer;
guiding means for guiding the two layers towards each other; and
a pair of adjacent laminating rollers for receiving the base veneer layer and the additional veneer layer therebetween, so as to continuously laminate the two layers as they move through the laminating rollers.

2. A system for laminating a plurality of veneer layers according to claim 1, wherein the additional veneer layer is impregnated with heat-activatable glue, with the system further including a bank of heating elements arranged to activate the glue on the additional veneer layer.

3. A system for laminating a plurality of veneer layers according to claim 2, wherein the glue is EVA hotmelt glue.

4. A system for laminating a plurality of veneer layers according to claim 1, which further includes a dynamic alignment arrangement for controlling the alignment of the veneer layers as they pass through the system.

5. A system for laminating a plurality of veneer layers according to claim 4, wherein the alignment arrangement includes:
at least one monitoring element for determining the alignment of the layers as they pass through the system; and
actuating means connected to the at least one monitoring element for adjusting the alignment of the layers.

6. A method of laminating veneer layers, the method comprising the steps of:
providing a base veneer layer;
providing at least one additional veneer layer that is to be laminated to the base veneer layer
guiding the two layers towards each other; and
providing a pair of adjacent laminating rollers for receiving the base veneer layer and the additional veneer layer therebetween, so as to continuously laminate the two layers as they move through the laminating rollers.

7. A method of laminating veneer layers according to claim 6, wherein the additional veneer layer is impregnated with heat-activatable glue.

8. A method of laminating veneer layers according to claim 7, wherein the method includes the step of activating the glue on the additional veneer layer.

9. A method of laminating veneer layers according to claim 6, wherein the method further includes the step of controlling the alignment of the veneer layers.

10. A roll of laminated veneer layers, made with the system defined in claim 1.

11. A roll of laminated veneer layers, made according to the method of claim 6.
